(19) United States
(12) Patent Application Publication
(10) Pub. No.: US 2025/0348511 A1
(43) Pub. Date: Nov. 13, 2025

(54) DATABASE SYNCHRONIZATION IN RESPONSE TO A UNIQUE PROVIDER OBJECT BEING COMPROMISED

(71) Applicant: AMADEUS S.A.S., Biot (FR)

(72) Inventors: Marco SALIBBA, Valbonne (FR); Emeline RADIGOIS, Valbonne (FR); Marjorie ZENTE, Antibes (FR); Louis Charles Jacques ROSSO, Falicon (FR); Michel DEMAZEAU, Nice (FR)

(21) Appl. No.: 19/175,696

(22) Filed: Apr. 10, 2025

Related U.S. Application Data
(60) Provisional application No. 63/646,155, filed on May 13, 2024.

(51) Int. Cl. G06F 16/27; G06F 21/62

(52) U.S. Cl. CPC G06F 16/273; G06F 21/6209

(57) ABSTRACT

A method for database synchronization in response to a unique provider object being compromised is described. The method comprises extracting data from a compromised provider object; building an injection query using the extracted data; adding a cross-reference element to the injection query, the cross-reference element including a provider object identifier for the compromised provider object; initiating creation of a clean provider object using the extracted data and the cross-reference element; forcing creation of the clean provider object; notifying third party systems of a provider object identifier for the created clean provider object; and deactivating the compromised provider object. An intermediation server configured to implement the method is also disclosed.

### CROSS REFERENCE TO RELATED APPLICATION

The present application claims priority to U.S. Provisional Patent Application No. 63/646,155 filed May 13, 2024, entitled DATABASE SYNCHRONIZATION IN RESPONSE TO A UNIQUE PROVIDER OBJECT BEING COMPROMISED, the entire contents of which are incorporated herein by reference.

The specification relates generally to maintaining and providing access to information stored in a database and identified by a unique provider object, and specifically to a device, system, and method for synchronizing data in response to the unique provider object being compromised.

### BACKGROUND

The provision of various products, including for example travel-related goods and services (e.g., flights, hotel reservations, and the like) typically requires various discrete entities to exchange data defining various aspects of the products. Examples of such entities, in the context of travel-related products, include airlines, travel agencies, travelers (end users), reservation systems, and the like.

A passenger name record (PNR), sometimes referred to a booking file, is a digital document with details of the itinerary for a passenger or a group of passengers traveling together for a given trip. It is an essential part of the flight booking process that precedes and enables ticketing.

A unique PNR code is assigned to each PNR upon creation. The PNR code is sometimes referred to as a record locator (RLOC), booking reference, reservation code, or just PNR. The PNR code usually contains six characters that include either letters or letters and numbers, depending on the system used to make a booking.

The PNR code is provided to travelers once they complete a reservation, which enables them to manage their trip and check-in online. The PNR code also gives travelers access to their flight details. Generally, the PNR is updated every time the reservation information for the trip is altered. At the end of the trip, the PNR is archived. Usually, the PNR is archived within one to five days after the final segment of the itinerary has been completed.

Standards for the PNR were initially developed by the International Air Transport Association (IATA), the International Civil Aviation Organization (ICAO), and Airlines for America, previously known as the Air Transport Association of America (ATA). Accordingly, although there is no universal format for the PNR, there are five essential elements for its creation. The required elements include: (1) a contact phone number; (2) a field identifying the last person to make a change to the PNR; (3) at least one journey segment for the trip; (4) the name(s) of the traveler(s); and (5) an indication as to how and when a ticket is to be issued. However, other optional components that may be stored in the PNR include: additional itinerary segments such flights, hotel reservations, car rentals; payment method (cash, credit/debit card, or check); credit card number; passenger email address; frequent flyer number; travel agency name and address; fare and pricing details; restrictions that may apply to the ticket; age details relevant to the travel; special service requests (SSRs) like meal or seating preferences; agency service fees; other remarks related to the trip; and historical changes to the PNR.

The number of incidents involving data leaks is increasing in all industries, including travel. These security incidents may occur for different reasons. For example, brute force attacks from hacker organizations can lead to the compromise of thousands, if not millions, of PNRs. Similarly, negligence by the traveler, such as sharing boarding pass and/or reservation on social media, can result in the compromise of the PNR. Further, it is necessary to share PNR code with many stakeholders (other airlines, vendors, partners), each of which has a different level of security.

However, online access to the PNR has a relatively low level of security, especially compared to offline access. All that is required to access the PNR online is the PNR code and the traveler's name. Airlines are reluctant to increase the security level required to access the PNR online so as not to impact the traveler user experience. Accordingly, traditional security methods such as multifactor authentication and one-time passwords for securing the PNR are not practical solutions. Moreover, the unique nature of the PNR code and the content stored therein further complicate attempts at securing the information at the PNR database.

Currently, when PNR codes are comprised an administrator of the PNR database is required to hard code one or more restrictions to the PNR. The restrictions limit or prevent travelers from directly accessing the PNR and directs them to a call center.

Accordingly, it is desirable to provide a database-implemented solution that obviates or mitigates the above-mentioned disadvantages.

### SUMMARY

In accordance with an aspect of an embodiment, there is provided a method comprising: extracting data from a compromised provider object; building an injection query using the extracted data; adding a cross-reference element to the injection query, the cross-reference element including a provider object identifier for the compromised provider object; initiating creation of a clean provider object using the extracted data and the cross-reference element; forcing creation of the clean provider object; notifying third party systems of a provider object identifier for the created clean provider object; and deactivating the compromised provider object.

Before extracting the data the provider objects may be filtered to identify provider objects that are eligible to be duplicated. Building the injection query may comprise converting at least some of the data from a format-specific format to a standard format. The data may be added to the injection query in the standard format. Building the injection query may also comprise adding at least some of the data to the injection query without converting the format of the data.

The injection query may include a replicated use case to indicate that the request provider object is going to be a duplicate of a compromised provider object. The third party systems may be notified that the provider object is a clean provider object by modifying a header in the communication protocol used to communicate the message.

Deactivating the compromised provider object may comprise at least one of: making the compromised provider object read only; restricting access to the compromised provider object; and password protecting the compromised provider object.

In accordance with an aspect of another embodiment, there is provided an intermediation server comprising a non-transitory computer readable medium storing instructions which, when executed by a processor, cause the processor to implement the method described above.

### BRIEF DESCRIPTION OF THE DRAWINGS

For a better understanding of the various examples described herein and to show more clearly how they may be carried into effect, reference will now be made, by way of example only, to the accompanying drawings in which:

FIG. 1 is a block diagram of a system for synchronizing data in response to the unique provider object being compromised;

FIG. 2 is a block diagram of an intermediation server illustrated in FIG. 1;

FIG. 3A and FIG. 3B are block diagrams illustrating the creation of a clean provider object from a compromised provider object; and

FIG. 4 is a flow diagram illustrating the method for creating a clean provider object from a compromised provider object

### DETAILED DESCRIPTION

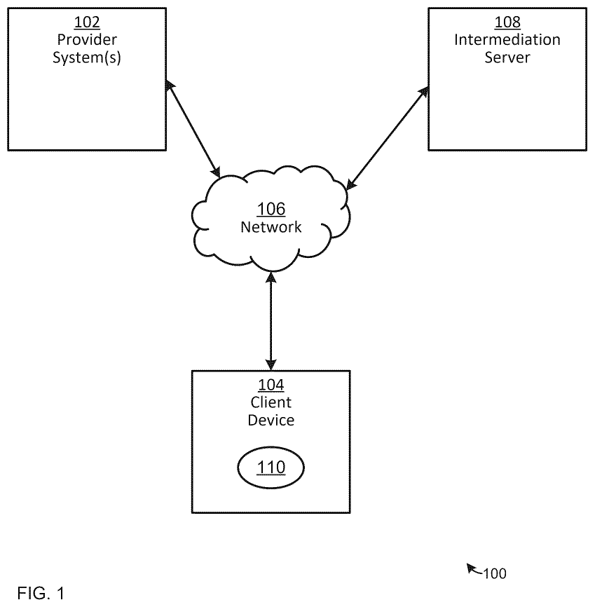

For convenience, like numerals in the description refer to like structures in the drawings. FIG. 1 depicts a system 100 for intermediation between a provider system (e.g., one or more servers or other suitable computing devices), and a client device. Provider objects, in the examples discussed herein, may comprise provider objects and/or data records which correspond to products and/or items, such as travel-related goods and services (e.g., flights, hotel reservations, car rentals and the like), provided by a provider system. More specifically, the products and/or items discussed in the examples below may be flight tickets and related services (e.g., limo pickup services, excursions at a destination, baggage check services, in-flight food, entertainment, pet-related services, and the like). A personal name record (PNR) is an example of a provider object. However, as will be apparent to those skilled in the art, the systems and methods discussed below can also be applied to various other types of data objects and/or items including, but not limited to, data objects correspond to any suitable products and/or any suitable items available (e.g., for purchase, and the like) from any suitable website, and the like.

Delivery of the items mentioned above is typically controlled by a provider entity, such as an airline in the case of the items discussed in connection with the travel-industry related examples provided herein. The system 100 includes one or more provider systems 102 (e.g., one or more servers or other suitable computing devices), which in this example is operated by one or more provider entities. The system 100 can include a plurality of client devices 104, although only one client device 104 is shown in FIG. 1 for illustrative purposes.

The system 100 can include a plurality of provider systems 102, each operated by respective provider entities (e.g., various airlines), although only one provider system 102 is shown for illustrative purposes. The provider objects may be in any suitable format including, but not limited to, Edifact recommendations in the context of Global Distribution System (GDS)-based data exchange, offer records in the context of New Distribution Capability (NDC)-based data exchange, and/or any other suitable format. Indeed, the provider objects may comprise data objects and/or data records, for example storing an Edifact recommendation or an NDC offer, and/or any other suitable data representing at least one item provided by the provider system 102.

A provider object is understood to define an item, or a combination of items, which may be offered for purchase (e.g., by end users of the items) including, but not limited to one or more of flights, train rides, hotel stays, airport lounge access, seat upgrades, baggage check services, in-flight food, entertainment, pickup services, excursion services, pet-related services, and the like, and/or associated services. Thus, in examples discussed below, a provider object may define a flight operated by the provider entity, and/or services associated with the flight, or proposed as standalone services. Each provider object therefore may contain various fields (e.g., data fields), and the like. Certain fields define item attributes, such as product object identifiers (e.g., service identifiers, item identifiers, product identifiers and the like), locations, dates and times corresponding to the products (e.g., flight times and other itinerary data). The type of fields and/or data of a provider object may depend on a type of a provider object. For example, provider objects corresponding to flights may include flight identifiers, whereas provider objects corresponding to other travel-related items, such as an offer for accessing an airport lounge and/or an offer for a premium seat upgrade, may include information related to the lounge, the premium seat, etc.

Requests for provider objects may be received at the provider system 102 from other components of the system 100. For example, the requests may be received from a client device 104, via a network 106 (e.g., any suitable combination of local and wide area networks, including the Internet) and via an intermediation server 108. As will be described below, the intermediation server 108 generally intermediates between the client device 104 and the provider system 102, for example such that the client device 104 may request products from the provider system 102, and/or more than one provider system 102, via the intermediation server 108.

Furthermore, in some embodiments, the intermediation server 108 may create the provider objects in response to requests from the provider systems. As will be described hereafter, in a specific non-limiting example, the intermediation server 108 may be further configured to mitigate exposure of provider objects to the public. This can be achieved, for example, by creating new provider objects and migrating data from the compromised provider objects to the newly created, clean provider objects. As will be described the intermediation server 108 is configured to overcome replication restrictions on the provider objects and use existing communication protocols to minimize changes required at the intermediation server 108 and the provider systems 102.

The client device 104, in the present example, may be operated by a travel agent entity, and therefore generates and provides requests for provider objects (e.g., representing products which may be for purchase), and/or requests to purchase products (e.g., represented by the provider objects), to the provider system 102, via the intermediation server 108, on behalf of travelers.

The client device 104 may be operated by the provider system 102. In yet another alternative, the provider system 102 may operate the intermediation server 108. Hence, it is understood that while the provider system 102, the client device 104 and the intermediation server 108 are all depicted as being separate from each other in FIG. 1, they may be associated with various combinations of one or more entities, and/or functionality of the provider system 102, the client device 104 and the intermediation server 108 may be combined in any suitable manner at one or more computing devices and/or servers and/or cloud computing devices. As such, herein, rather than refer to components of the system 100 communicating via transmitting data therebetween (e.g., such as via the network 106), herein communication between components of the system 100 is referred to as the components providing data, and the like, therebetween which may include, but is not limited to, transmitting data over the network 106, communicating data when the components are local to each other and/or combined, and the like.

Various other mechanisms for initiating the creation of the provider objects are also contemplated. For example, travelers (via the client device 104 and/or client devices and/or additional computing devices, not shown in FIG. 1) may initiate the creation of the provider objects via direct interaction with a website hosted by the intermediation server 108. Various mechanisms for the creation of provider objects will be apparent to those skilled in the art.

The client device 104 is configured to receive data contained in the provider objects via the intermediation server 108. Data obtained by the client device 104, via the intermediation server 108, may be presented to users served by the client device 104, for example via a display screen (not depicted) which may be local to the client device 104; further information associated with the items represented by the provider objects may be requested by the client device 104 which may include, but is not limited to the client device 104 ordering the items. In other words, the system 100 enables the client device 104 to request further information associated with the items represented by the provider objects, via the intermediation server 108. The client device 104 may be configured to request the further information and/or initiate such orders by providing requests to the provider system 102 via the intermediation server 108.

The provider objects provided by the provider system 102 generally include provider object data representing at least one item provided by the provider system 102. The provider object data includes a provider object identifier, such as a record locator (RLOC) code for example, and/or provider object identifier data, that identifies the provider object to the provider system 102. The provider object data generally comprises information that identifies a travel related product and/or service.

In general, communication between the client device 104 and the intermediation server 108 occurs via a computing-process flow 110 implemented by the client device 104, such as an Applications Programming Interface (API), and the like. For example, during ordering of a provider object (e.g., booking a flight), the client device 104 may implement the computing-process flow 110 in the form of an API, and communications between the client device 104 and the intermediation server 108 may be defined by the API.

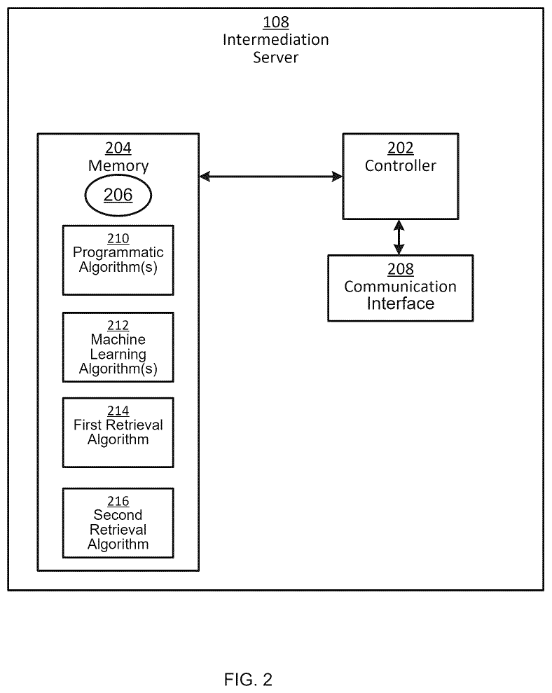

Turning to FIG. 2, before discussing the functionality of the system 100 in greater detail, certain components of the intermediation server 108 will be discussed in greater detail. While depicted as one device, the intermediation server 108 may comprise one or more computing devices and/or one or more servers and/or one or more cloud computing devices that may be geographically distributed.

As shown in FIG. 2, the intermediation server 108 includes at least one controller 202, such as a central processing unit (CPU) or the like. The controller 202 is interconnected with a memory 204 storing an application 206, the memory 204 implemented as a suitable non-transitory computer-readable medium (e.g., a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The controller 202 and the memory 204 are generally comprised of one or more integrated circuits (ICs).

The controller 202 is also interconnected with a communication interface 208, which enables the intermediation server 108 to communicate with the other computing devices of the system 100 (i.e. the provider systems 102 and the client device 104) via the network 106, though it is understood such communication may occur locally when components of the system 100 are combined. The communication interface 208 therefore may include any necessary components (e.g., network interface controllers (NICs), radio units, and the like) to communicate via the network 106. The specific components of the communication interface 208 may be selected based on upon the nature of the network 106 and/or local communication between components of the system 100, and the like. The intermediation server 108 can also include input and output devices connected to the controller 202, such as keyboards, mice, displays, and the like (not shown).

The components of the intermediation server 108 mentioned above can be deployed in a single enclosure, or in a distributed format. In some examples, therefore, the intermediation server 108 includes a plurality of processors, either sharing the memory 204 and communication interface 208, or each having distinct associated memories and communication interfaces. As such, it is understood that the memory 204, and/or a portion of the memory 204, may be internal (e.g., as depicted) or external to the intermediation server 108; regardless, the controller 202 is understood to have access to the memory 204.

The memory 204 also stores a plurality of computer-readable programming instructions, executable by the controller 202, in the form of various applications, including the application 206. As will be understood by those skilled in the art, the controller 202 executes the instructions of the application 206 (and any other suitable applications) in order to perform various actions defined by the instructions contained therein. In the description below, the controller 202, and more generally the intermediation server 108, are said to be configured to perform those actions. It will be understood that they are so configured via the execution (by the controller 202) of the instructions of the applications stored in memory 204.

In some examples, execution of the application 206, as will be discussed below, configures the intermediation server 108 to implement functionality for database synchronization in response to exposure of one or more of the provider objects to the public. As will be described in more detail below, in some examples, the application 206 may comprise and/or have access to, one or more programmatic algorithms 210, extracting the data from the exposed provider objects and using the extracted data to force the creation of new provider objects. While the one or more programmatic algorithms 210 are depicted in FIG. 2 as being separate from the application 206, the one or more programmatic algorithms 210 may be integrated with the application 206 and/or the one or more programmatic algorithms 210 may comprise modules of the application 206.

While present examples are described with respect to the one or more programmatic algorithms 210 creating new provider objects for exposed provider objects generated by one provider system 102, one or more programmatic algorithms 210 may be provided to create new provider objects for exposed provider objects generated by a plurality of provider system 102.

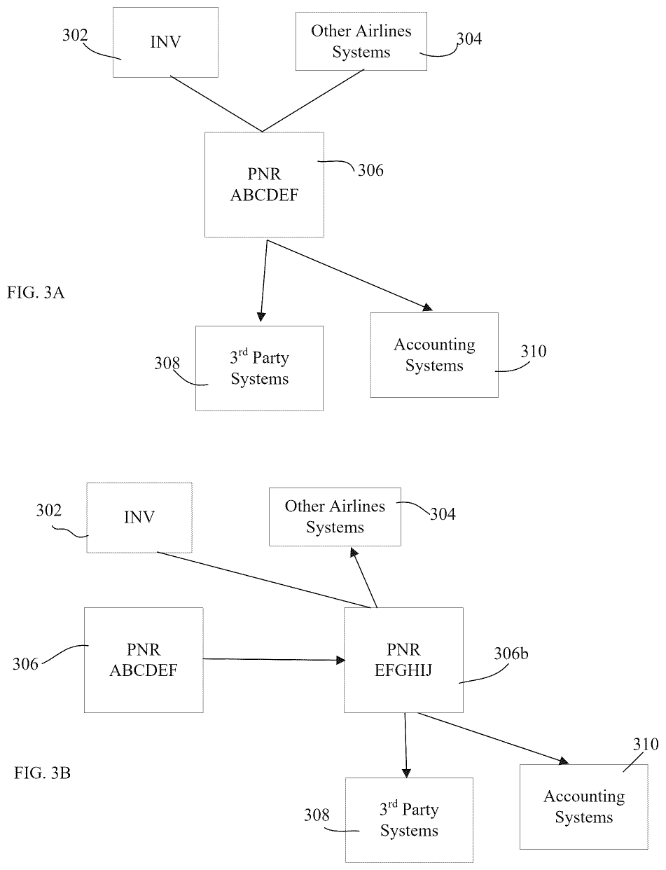

Turning to FIG. 3A, a block diagram illustrating access to provider objects is illustrated generally by number 300. In FIG. 3, a provider object 306 has already been established using any method known in the art. The provider object 306 has a unique data set and has been assigned a provider object identifier. In the illustrated example, the provider object 306 is a PNR for travel and the PNR code is ABCDEF. The PNR 306 can be accessed by and/or shared with invoicing system 302, other airline systems 304, third party systems 308, and accounting systems 310. Accordingly, it will be appreciated that multiple parties share access to the same PNR. Thus, if the PNR is compromised it can be complex to address and correct the issue while maintaining ready access by all legitimate parties.

In some embodiments, the provider object 306 is replicated if it is determined that the provider object 306 has been compromised. Note that how it is determined that the provider object or objects have been compromised is beyond the scope of the present disclosure. Turning to FIG. 3B, a block diagram illustrating replicating the provider objects 306 is illustrated generally by number 300. Similar to FIG. 3A, the provider object 306 is a PNR. Once it is determined that the PNR 306 has been, or may have been, compromised, a new, uncompromised or clean PNR 306a is created having the same data set as the compromised PNR 306. For clarity, the term “clean” is used herein to refer to the cleansed or recycled counterpart to the compromised PNR or provider object. It is not meant to imply that only cleansed or recycled PNRs or provider objects are clean. The clean PNR 306b is assigned a new PNR code, which in this example is EFGHIJ. The new PNR code is communicated to the Other Airlines Systems 304 so that they can update their records accordingly. Similarly, the new PNR code is sent to the third-party systems 308 and the accounting systems 310. The compromised PNR 306 is inactivated and has restrictions imposed on it.

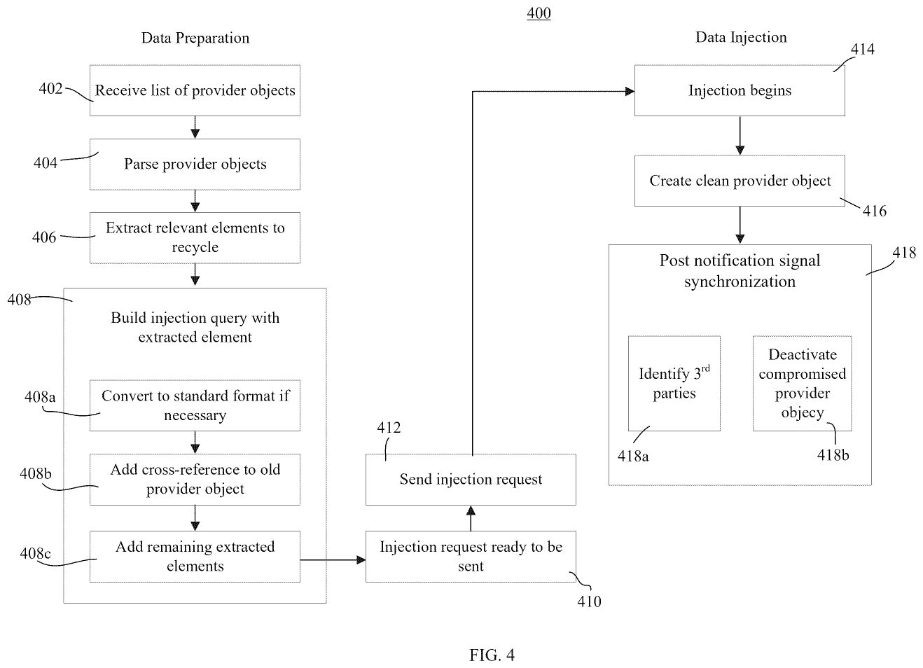

Referring to FIG. 4, the process for replicating the provider object 306 is illustrated generally by numeral 400. In some embodiments, the process 400 is implemented by the programmatic algorithms 210 at the intermediation server 108. Initially, a list of compromised or potentially compromised, provider objects is received 402. The list may be as few as one provider object if, for example, an end user self-reports that the provider object may be comprised by accidental disclosure of the provider object identifier. Alternatively, the list may comprise thousands, hundreds of thousands, or even millions of provider object identifiers if, for example, one of the provider system 102 or the client devices 104 is hacked. As previously noted, how the provider objects were compromised and how that compromise was detected is beyond the scope of the present disclosure.

The list of compromised, or potentially compromised, provider objects are parsed 404 to determine if they are eligible to be replicated. For example, some provider systems 102 may not be configured to properly store and process replicated provider objects. In another example, the provider object may include non-supported content. In yet another example, the provider object may include only past events. As will be appreciated, there may be other reasons that the provider object is not to be replicated. Any ineligible provider objects are excluded from the replication process and are handled as is standard in the art or in a customized manner.

For each eligible provider object, data, in the form of elements, is extracted 406 from the provider object. Elements that are extracted include traveler details, future itineraries, services, ticket details, and the like. The extracted elements are used to build 408 an injection query for creating a new provider object as follows. In some embodiments, one or more of the extracted elements may be in a format specific to the intermediation server 108. Accordingly, extracted elements that are format-specific are converted 408a to standard format elements. The converted standard format elements are added to the injection query. A cross-reference element is created 408b and added to the injection query. The cross-reference element includes the provider object identifier of the compromised provider object. The cross-reference element can be used to provide a link from the newly created provider object to the compromised provider object from which it was created. In some embodiments, the cross-reference element is stored in a pre-defined element that is no longer in use. This avoids requiring changes to the provider object creation process and minimizes the likelihood of collisions among the provider object elements. The remaining extracted elements are added 408c to the injection query. The remaining elements include those that did not need to be converted to from the format-specific format to the standard format. Once all the necessary elements have been added to the injection request, the injection request is ready to be sent 410.

Once the injection query is ready to be sent 410, it is transmitted 412 to a provider object creation module. The injection query includes a “replicated” use case. As will be appreciated, a use case in the context of creating the provider object refers to a specific scenario or set of conditions under which it is created to meet particular requirements or solve specific problems. Use cases help define the purposes and functionalities needed from the provider object. Examples of known use cases for creating a PNR in the travel industry include: individual bookings, group bookings, corporate travel, and multi-segment/multi-carrier travel.

The provider object creation module is implemented by the programmatic algorithms 210 at the intermediation server 108. Because the injection query has a “replicated” use case, the provider object injection begins 414 and a new provider object is attempted to be created using duplicate data to an existing provider object (i.e. the compromised provider object). Because standard provider object creation is configured to avoid creating duplicate provider objects, safeguards are in place to limit the likelihood of creating duplicates. For example, most of the existing programmatic algorithms 210 are configured on the basis that if a matching provider object exists in the system, it must be updated. As a consequence, in some embodiments, the programmatic algorithms 210 are configured to locate duplicates when a request for creating the provider object is received. start with a search operation to locate a potentially existing provider object. For example, for a PNR, the search could be initiated using a flight number, a flight date, and one or more passenger names. Further, in some embodiments, all update processes are configured to start with the search operation to locate a potentially existing provider object. The existing programmatic algorithms 210 further include processes dedicated to scan the provider objects in search of duplicates. If found, the duplicates may be flagged, merged, or automatically cancelled.

Since the use case is defined as “replicated”, the provider object creation module is configured to overcome these safeguards. To facilitate the replication process, new programmatic algorithms 210 are required to ensure that the creation of the duplicate provider object is permitted under the desired conditions and that the existing merge/search operations described above are subsequently avoided.

The creation of the clean provider object is monitored for possible errors and automatically retried until its creation is successful. In some embodiment, a maximum number of retries can be defined. In the maximum number of retries is exceeded without success, human intervention may be necessary to correct the injection message and restart the injection request.

By overcoming the safeguards, the clean provider object is created 416. The clean provider object includes elements from the compromised provider object. In existing systems, such elements are uniquely associated with only one provider object. Accordingly, some extra steps are necessary to maintain system integrity.

Once the clean provider object is created and committed, a notification signal is generated. This is the same notification signal that is generated when a typical provider object is created. For example, when a PNR is created and committed, an end of transmission (EOT) signal is generated. The EOT signal indicates that the PNR code can be communicated to the respective parties involved with the PNR. However, since the use case is defined as “replicated”, post notification signal synchronization is performed 418 specifically for the “replicated” use case.

That is, when the provider object identifier for the clean provider object is transmitted 418a to the third party systems, it is identified as a clean provider object. For example, the message is transmitted using standard messaging, similar to that for a typical provider object. However, a message header is modified to indicate that the provider object identifier references a clean provider object. In alternative embodiments, the indication that the provider object identifier references a clean provider object may be included in the body of the message rather than the header.

When the third party receives the message, they can access the clean provider object and retrieve the identifier of the compromised provider object. The third party can then modify their system so that any records referencing the compromised provider object identifier can be updated to reference the clean provider object identifier. In some embodiments, the message may include the provider object identifier of the compromised provider object in the body and/or the header. In such embodiments, the third party can immediately update their system without having to access the clean provider object.

Further, the “replicated” post notification signal synchronization includes deactivating 418b the compromised provider object. In some embodiments, deactivating the compromised provider object includes making the compromised provider object read only. In some embodiments, deactivating the compromised provider object includes restricting access to the compromised provider object. For example, the compromised provider object may be restricted to allow only users assigned a very specific permission. This permission is administrated at the intermediation server 108 and limited to only a few trained people. Thus, the legitimate owner of the compromised provider object will have to request access from the operator of the intermediation server 108 and follow a strict access procedure. In some embodiments, deactivating the compromised provider object includes adding password protection to the compromised provider object. Various combinations of these embodiments may be employed to facilitate deactivation of the compromised provider object.

The description above describes the creation of a new, clean provider object that is created to replace a provider object that has been compromised. Access to the compromised provider object is restricted to avoid fraud. Thus, it will be appreciated that secured access to personal information stored in the provider object can provided without impacting the end user experience. Further, emergency data leaks can be dealt with in real time. This reduces potential fraud and information misusage.

As should by now be apparent, the operations and functions of the devices described herein are sufficiently complex as to require their implementation on a computer system, and cannot be performed, as a practical matter, in the human mind. In particular, computing devices, and the lie, such as set forth herein are understood as requiring and providing speed and accuracy and complexity management that are not obtainable by human mental steps, in addition to the inherently digital nature of such operations (e.g., a human mind cannot interface directly with, RAM or other digital storage, cannot transmit or receive electronic messages, among other features and functions set forth herein).

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
extracting data from a compromised provider object;
building an injection query using the extracted data;
adding a cross-reference element to the injection query, the cross-reference element including a provider object identifier for the compromised provider object;
initiating creation of a clean provider object using the extracted data and the cross-reference element;
forcing creation of the clean provider object;
notifying third party systems of a provider object identifier for the created clean provider object; and
deactivating the compromised provider object.

2. The method of claim 1, wherein before extracting the data the provider objects are filtered to identify provider objects that are eligible to be duplicated.

3. The method of claim 1, wherein building the injection query comprises converting at least some of the data from a format-specific format to a standard format; and adding the data to the injection query in the standard format.

4. The method of claim 1, wherein building the injection query comprises adding at least some of the data to the injection query without converting the format of the data.

5. The method of claim 1, wherein the injection query includes a replicated use case to indicate that the requested provider object is going to be a duplicate of a compromised provider object.

6. The method of claim 1, wherein the third party systems are notified that the provider object is a clean provider object by modifying a header in a communication protocol used to communicate the message.

7. The method of claim 1, wherein deactivating the compromised provider object comprises at least one of: making the compromised provider object read only; restricting access to the compromised provider object; and password protecting the compromised provider object.

8. An intermediation server comprising a non-transitory computer readable medium storing instructions which, when executed by a processor, cause the processor to:
extract data from a compromised provider object;
build an injection query using the extracted data;
add a cross-reference element to the injection query, the cross-reference element including a provider object identifier for the compromised provider object;
initiate creation of a clean provider object using the extracted data and the cross-reference element;
force creation of the clean provider object;
notify third party systems of a provider object identifier for the created clean provider object; and
deactivate the compromised provider object.

9. The intermediation server of claim 8, wherein before extracting the data the provider objects are filtered to identify provider objects that are eligible to be duplicated.

10. The intermediation server of claim 8, wherein building the injection query comprises converting at least some of the data from a format-specific format to a standard format; and adding the data to the injection query in the standard format.

11. The intermediation server of claim 8, wherein building the injection query comprises adding at least some of the data to the injection query without converting the format of the data.

12. The intermediation server of claim 8, wherein the injection query includes a replicated use case to indicate that the requested provider object is going to be a duplicate of a compromised provider object.

13. The intermediation server of claim 8, wherein the third party systems are notified that the provider object is a clean provider object by modifying a header in a communication protocol used to communicate the message.

14. The intermediation server of claim 8, wherein deactivating the compromised provider object comprises at least one of: making the compromised provider object read only; restricting access to the compromised provider object; and password protecting the compromised provider object.
